(19) United States
(12) Patent Application Publication
(10) Pub. No.: US 2022/0057908 A1
(43) Pub. Date: Feb. 24, 2022

(54) TOUCH INPUT ACTIVATION

(71) Applicant: Sentons Inc., Grand Cayman (KY)

(72) Inventors: Samuel W. Sheng, Saratoga, CA (US); Robert Drew Tausworthe, Saratoga, CA (US); Lapoe E. Lynn, Los Altos, CA (US)

(21) Appl. No.: 17/000,350

(22) Filed: Aug. 23, 2020

(51) Int. Cl. G06F 3/041

(52) U.S. Cl. CPC G06F 3/04144; G06F 2203/04105; G06F 3/0416

(57) ABSTRACT

A device activation system is described. The device activation system includes a sensor and a signal processor. The signal processor receives a disturbance detection signal from the sensor. In response, the signal processor enables detection of a power-on touch input.

### BACKGROUND OF THE INVENTION

Various electrical components can be used to detect a physical disturbance (e.g., strain, force, pressure, vibration, etc.) and provide a corresponding signal. For example, a component may detect expansion of or pressure on a particular region on a device and provide an output signal in response. Such components may be utilized in devices to detect a touch. For example, a component mounted on a portion of the mobile phone may detect an expansion or flexing of the portion to which the component is mounted and provide an output signal. The output signal from the component can be considered to indicate a purposeful touch (a touch input) of the mobile phone by the user. However, a mobile phone may undergo flexing and/or localized pressure increases for reasons not related to a user's touch. In addition, a user touching other regions of the mobile phone may result in an expansion and/or local pressure increase of the portion to which the component is connected. Such situations can result in false detections of touch inputs. Other situations in which a user purposefully touches a region of the mobile device may not result in detection of a touch input. This issue may be exacerbated if a touch input is desired to be used to control power in a device. The device is desired to be turned on or off in response to a touch input, but not in response to false detections of touch inputs. Consequently, an improved mechanism for accurately detecting touch input is desired.

### BRIEF DESCRIPTION OF THE DRAWINGS

Various embodiments of the invention are disclosed in the following detailed description and the accompanying drawings.

FIG. 1 is a schematic diagram illustrating an embodiment of a piezoresistive bridge structure usable as a strain sensor.

FIG. 2 depicts an embodiment of an integrated sensor.

FIG. 3 is a block diagram illustrating an embodiment of a system for detecting a touch inputs.

FIG. 4 is a diagram depicting an embodiment of a device utilizing touch inputs for device activation.

FIG. 5 is a diagram depicting an embodiment of a device utilizing touch inputs for device activation.

FIG. 6 is a diagram depicting an embodiment of a device utilizing touch inputs for device activation.

FIG. 7 is a flow chart depicting an embodiment of a method for utilizing touch inputs for device activation.

FIG. 8 is a flow chart depicting an embodiment of a method for utilizing touch inputs for device activation.

FIG. 9 is a flow chart depicting an embodiment of a method for utilizing touch inputs for device activation.

FIG. 10 is a flow chart depicting an embodiment of a method for calibrating sensors for use in detecting touch inputs for device activation.

FIG. 11 is a diagram depicting a system for maintaining a signal processor.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

User touches of a device such as a mobile phone (e.g. a smart phone) or touch screen are desired to be detected. Further, purposeful touches by a user (touch inputs) are desired to be distinguished from other physical input, such as bending of the device and environmental factors that can affect the characteristics of the device, such as temperature changes. In some embodiments, therefore, a touch input includes touches by the user, but excludes bending and temperature effects. For example, a swipe or press of a particular region of a mobile phone is desired to be detected as a touch input, while a user sitting on the phone or a rapid change in temperature of the mobile phone should not to be determined to be a touch input. Similarly, characteristics of the user are desired to not adversely affect utilization of the device. For example, the user wearing a glove is desired to not significantly impact the ability to detect a touch input by the user's (gloved) hand.

Touch inputs may also be used to activate a device. Such a device is desired to be powered on and off in response to a touch input, but not in response to a false detection of a touch input. Devices are also desired to undergo shipping and arrive at their destinations while maintaining operability. For example, a mobile phone is desired not to falsely detect touch inputs, particularly while powered off. Failure to prevent false detections of touch inputs during shipping could result in the mobile phone being powered on throughout a significant fraction shipping. In such a case, the mobile phone may arrive at its destination with less battery power remaining than is desired. Consequently, an improved mechanism for accurately detecting touch inputs, particularly for activating the device, is desired.

A device activation system includes sensor(s) and signal processor(s). For example, the sensor(s) may be force sensor(s) such as strain gauge(s) and/or touch sensor(s) such as piezoelectric device(s). The sensor(s) determine that a disturbance has occurred at a device and provide a disturbance detection signal. For example, a force sensor may be used to detect bends in the device due to the device being picked up. A touch sensor may be used as a microphone to detect noise due to the device being picked up. The disturbance detection signal may thus be based on detection of a strain by the force sensor and/or be an acoustic-based detection signal from the touch sensor.

The signal processor(s) receive the disturbance detection signal from the sensor(s) and enable detection of a power-on touch input in response. For example, the signal processor(s) may receive the disturbance detection signal from force and/or touch sensor(s). In some embodiments, the signal processor(s) receive the disturbance detection signal from a single force or touch sensor. In enable detection of the power-on touch input, the signal processor(s) may utilize a first encoded signal at a first frequency to query at least a portion of a plurality of sensors. These sensors may include force sensors. In some embodiments, the device is activated (powered on) in response to the power-on touch input being detected within the time interval. The signal processor(s) return to a low power mode if the power-on touch input is not detected within a time interval. In some embodiments, the signal processor(s) provide a second encoded signal to the force sensor in the low power mode. The disturbance detection signal received from the force sensor corresponds to this second encoded signal. In some embodiments, the first encoded signal has a first signal-to-noise ratio and the second encoded signal has a second signal-to-noise ratio not less than the first signal-to-noise ratio. In some embodiments, the first encoded signal includes a first pseudo-random binary sequence (PRBS) signal and the second encoded signal includes a second PRBS signal having more bits per sequence than the first PRBS signal. In some embodiments, the first PRBS signal has a first frequency and the second PRBS signal has a second frequency greater than the first frequency. Thus, the activation detection system may improve use of touch inputs for powering on and off devices while allowing for shipping that conserves power.

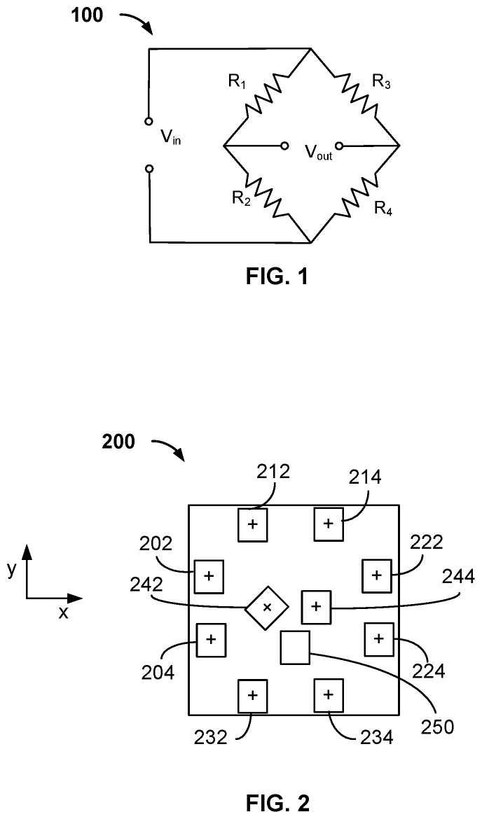

FIG. 1 is a schematic diagram illustrating an embodiment of a piezoresistive bridge structure that can be utilized as a strain sensor. Piezoresistive bridge structure 100 includes four piezoresistive elements that are connected together as two parallel paths of two piezoresistive elements in series (e.g., Wheatstone Bridge configuration). Each parallel path acts as a separate voltage divider. The same supply voltage (e.g., Vᵢₙ of FIG. 1) is applied to both of the parallel paths. By measuring a voltage difference (e.g., Vₒᵤₜ of FIG. 1) between a mid-point at one of the parallel paths (e.g., between piezoresistive elements R₁ and R₂ in series as shown in FIG. 1) and a mid-point of the other parallel path (e.g., between piezoresistive elements R₃ and R₄ in series as shown in FIG. 1), a magnitude of a physical disturbance (e.g. strain) applied on the piezoresistive structure can be detected.

In some embodiments, rather than individually attaching separate already manufactured piezoresistive elements together on to a backing material to produce the piezoresistive bridge structure, the piezoresistive bridge structure is manufactured together as a single integrated circuit component and included in an application-specific integrated circuit (ASIC) chip. For example, the four piezoresistive elements and appropriate connections between are fabricated on the same silicon wafer/substrate using a photolithography microfabrication process. In an alternative embodiment, the piezoresistive bridge structure is built using a microelectromechanical systems (MEMS) process. The piezoresistive elements may be any mobility sensitive/dependent element (e.g., as a resistor, a transistor, etc.).

FIG. 2 is a block diagram depicting an embodiment of integrated sensor 200 that can be used to sense forces (e.g. a force sensor). In particular, forces input to a device may result in flexing of, expansion of, or other physical disturbance in the device. Such physical disturbances may be sensed by force sensors. Integrated sensor 200 includes multiple strain sensors 202, 204, 212, 214, 222, 224, 232, 234, 242 and 244. Each strain sensor 202, 204, 212, 214, 222, 224, 232, 234, 242 and 244 may be a piezoresistive element such as piezoresistive element 100. In other embodiments, another strain measurement device might be used. Strain sensors 202, 204, 212, 214, 222, 224, 232, 234, 242 and 244 may be fabricated on the same substrate. Multiple integrated sensors 200 may also be fabricated on the same substrate and then singulated for use. Integrated sensor 200 may be small, for example five millimeters by five millimeters (in the x and y directions) or less.

Each strain sensor 202, 204, 212, 214, 222, 224, 232, 234, 242 and 244 is labeled with a +sign indicating the directions of strain sensed. Thus, strain sensors 202, 204, 212, 214, 222, 224, 232, 234 and 244 sense strains (expansion or contraction) in the x and y directions. However, strain sensors at the edges of integrated sensor 200 may be considered to sense strains in a single direction. This is because there is no expansion or contraction beyond the edge of integrated sensor 200. Thus, strain sensors 202 and 204 and strain sensors 222 and 224 measure strains parallel to the y-axis, while strain sensors 212 and 214 and strain sensors 232 and 234 sense strains parallel to the x-axis. As can be seen in FIG. 2, strain sensor 242 has been configured in a different direction. Thus, strain sensor 242 measures strains in the xy direction (parallel to the lines x=y or x=−y). For example, strain sensor 242 may be used to sense twists of integrated sensor 200. In some embodiments, the output of strain sensor 242 is small or negligible in the absence of a twist to integrated sensor 200 or the surface to which integrated sensor 200 is mounted.

Thus, integrated sensor 200 obtains ten measurements of strain: four measurements of strain in the y direction from strain sensors 202, 204, 222 and 224; four measurements of strain in the x direction from sensors 212, 214, 232 and 234; one measurement of strains in the xy direction from sensors 242 and one measurement of strain from sensor 244. Although ten strain measurements are received from strain sensors 202, 204, 212, 214, 222, 224, 232, 234, 242 and 244, six measurements may be considered independent. Strain sensors 202, 204, 212, 214, 222, 224, 232, and 234 on the edges may be considered to provide four independent measurements of strain. In other embodiments, a different number of strain sensors and/or different locations for strain sensors may be used in integrated sensor 200.

Integrated sensor 200 also includes temperature sensor 250 in some embodiments. Temperature sensor 250 provide an onboard measurement of the temperatures to which strain sensors 202, 204, 212, 214, 222, 224, 232, 234, 242 and 244 are exposed. Thus, temperature sensor 200 may be used to account for drift and other temperature artifacts that may be present in strain data. Integrated sensor 200 may be used in a device for detecting touch inputs.

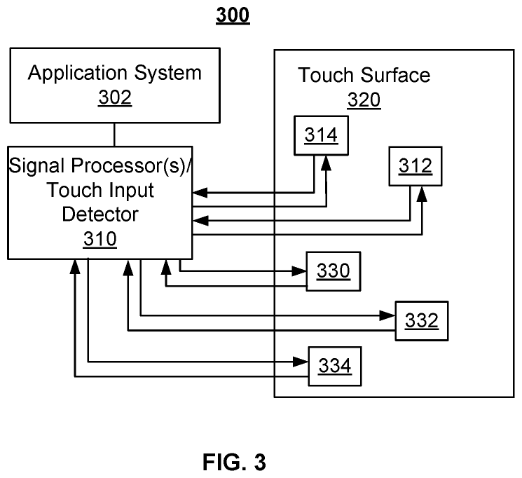

FIG. 3 is a block diagram illustrating an embodiment of system 300 for detecting a touch input. System 300 may be considered part of a device utilizing touch inputs. System 300 may also be usable in activating the device. Thus, system 300 may be part of a kiosk, an ATM, a computing device, an entertainment device, a digital signage apparatus, a mobile phone, a tablet computer, a point of sale terminal, a food and restaurant apparatus, a gaming device, a casino game and application, a piece of furniture, a vehicle, an industrial application, a financial application, a medical device, an appliance, and any other objects or devices having surfaces for which a touch input is desired to be detected.

System 300 is connected with application system 302 and touch surface 320, which may be considered part of the device with which system 300 is used. System 300 includes signal processor 310, force sensors 312 and 314, transmitter 330 and touch sensors 332 and 334. For simplicity, only some portions of system 300 are shown. Touch surface 320 is a surface on which touch inputs are desired to be detected. For example touch surface may include the display of a mobile phone, the touch screen of a laptop, an edge of a mobile phone, a portion of the frame of the device or other surface. Force sensors 312 and 314 may be integrated sensors including multiple strain sensors, such as integrated sensor 200. In other embodiments, force sensors 312 and 314 may be an individual strain sensor, such as sensor 100. Other force sensors may also be utilized. Although two force sensors 312 and 314 are shown, another number is typically present. Touch sensors 330 and 332 may be piezoelectric devices. Transmitter 330 may also be a piezoelectric device. In some embodiments, touch sensors 330 and 332 and transmitter 330 are interchangeable. Touch sensors 330 and 332 may be considered receivers of an ultrasonic wave transmitted by transmitter 330. In other cases, touch sensor 332 may function as a transmitter, while transmitter 330 and touch sensor 334 function as receivers. Thus, a transmitter-receiver pair may be viewed as a touch sensor in some embodiments. Multiple receivers may share a transmitter in some embodiments. Although only one transmitter 330 is shown for simplicity, multiple transmitters may be used. Similarly, although two touch sensors 332 and 334 are shown, another number may be used. Application system 302 may include the operating system for the device in which system 300 is used.

In some embodiments, signal processor 310 is part of an integrated circuit chip. Signal processor 310 includes one or more microprocessors that process instructions and/or calculations that can be used to program software/firmware and/or process data for signal processor 310. In some embodiments, signal processor 310 includes a memory coupled to the microprocessor and configured to provide the microprocessor with instructions. Other components such as digital signal processors may also be used. Although one signal processor is shown in FIG. 3, multiple signal processors may be used.

Signal processor 310 receives input from force sensors 312 and 314, touch sensors 332 and 334 and, in some embodiments, transmitter 330. For example, signal processor 310 receives force (e.g. strain) measurements from force sensors 312 and 314 and touch (e.g. piezoelectric voltage) measurements from touch sensors 332 and 334. Signal processor 310 may provide signals and/or power to force sensors 312 and 314, touch sensors 332 and 334 and transmitter 330. For example, signal processor 310 may provide the input voltage(s) to force sensors 312 and 314, voltage or current to touch sensor(s) 332 and 334 and a signal to transmitter 330. Signal processor 310 utilizes the force (strain) measurements and/or touch (piezoelectric) measurements to determine whether a user has provided touch input touch surface 320. If a touch input is detected, signal processor 310 provides this information to application system 302 for use.

Signals provided from force sensors 312 and 314 are received by signal processor 310 and may be conditioned for further processing. For example, signal processor 310 receives the strain measurements output by force sensors 312 and 314 and may utilize the signals to track the baseline signals (e.g. voltage, strain, or force) for force sensors 312 and 314. Strain measurements due to temperature may also be accounted for by signal processor 310 using signals from a temperature sensor, such as temperature sensor 250. Thus, signal processor 310 may obtain absolute forces (the actual force on touch surface 320) from force sensors 312 and 314 by accounting for temperature. In some embodiments, a model of strain versus temperature for force sensors 312 and 314 is used. In some embodiments, a model of voltage or absolute force versus temperature may be utilized to correct force measurements from force sensors 312 and 314 for temperature.

In some embodiments, touch sensors 332 and 334 sense touch via a wave propagated through touch surface 320, such as an ultrasonic wave. For example, transmitter 330 outputs such an ultrasonic wave. Touch sensors 332 and 334 function as receivers of the ultrasonic wave. In the case of a touch by a user, the ultrasonic wave is attenuated by the presence of the user's finger (or other portion of the user contacting touch surface 320). This attenuation is sensed by one or more of touch sensors 332 and 334, which provide the signal to signal processor 310. The attenuated signal can be compared to a reference signal. A sufficient difference between the attenuated signal and the reference signal results in a touch being detected. In some embodiments, absolute forces may be obtained from the touch measurements.

Encoded signals may be used in system 300. In some embodiments, transmitter 330 provides an encoded signal. The encoded signal may be used for touch sensors 332 and 334, as described above, and/or force sensors 312 and 314. For example, transmitter 330 may use a first pseudo-random binary sequence (PRBS) to transmit a signal. If multiple transmitters are used, the encoded signals may differ to be able to discriminate between signals. For example, the first transmitter may use a first PRBS and the second transmitter may use a second, different PRBS which creates orthogonality between the transmitters and/or transmitted signals. Such orthogonality permits a processor, such as signal processor 310, or sensor coupled to the receiver to filter for or otherwise isolate a desired signal from a desired transmitter. In some embodiments, the different transmitters use time-shifted versions of the same PRBS. In some embodiments, the transmitters use orthogonal codes to create orthogonality between the transmitted signals (e.g., in addition to or as an alternative to creating orthogonality using a PRBS). In various embodiments, any appropriate technique to create orthogonality may be used. In some embodiments, encoded signals may also be used for force sensors 312 and 314. For example, an input voltage for the force sensors 312 and 314 may be provided. Such an input signal may be encoded using PRBS or another mechanism.

The encoded signal utilized may be different for different modes of system 300. For a low power mode used during shipping of system 300, an encoded signal having a first signal-to-noise ratio (SNR) may be used. Once the system enters normal operation, an encoded signal that has a second SNR is used. The second SNR is greater than or equal to the first SNR. In some embodiments, the second SNR is greater than the first SNR. This allows for improved detection (e.g. fewer false positives) but may consume more power. Even if the second SNR is the same as the first SNR, the detection of a power on touch input using two signals still improves reliability of detection over the use of a single encoded signal alone. For example, in a low power mode (e.g. used during shipping of system 300), signal processor 310 may provide an input voltage to force sensors 312 and 314 in the form of a PRBS6 (sixty-four bit) sequence, which conserves power but is less complex (e.g. has fewer bits per sequence). During normal operation of system 300, signal processor 310 may utilize a PRBS9 (five hundred and twelve bit) sequence for force sensors 312 and 314, which requires more power but is more complex (e.g. utilizes more bits per sequence). Further, the frequency at which signal processor 310 emits sequences may vary. For example, a lower frequency may be used for low power modes of system 300. In the low power mode of the example above, the PRBS6 sequence signal may be emitted at a frequency of 0.5 Hz or 1 Hz. During normal operation, the PRBS9 sequence signal may be emitted at a frequency of 10 Hz or more. Thus, power may be conserved in the low power mode, while detection improved via a higher frequency during normal operation.

Thus, using the combination of force sensors 312 and 314 and touch sensors 332 and 334, touch inputs may be detected. Further, based upon which sensor 312, 314, 332 and/or 334 detects the touch and/or characteristics of the measurement (e.g. the magnitude of the force detected), the location of the touch in addition to the presence of a touch may be identified. For example, given an array of force and/or touch sensors, a location of a touch input may be triangulated based on the detected force and touch measurement magnitudes and the relative locations of the sensors that detected the various magnitudes (e.g., using a matched filter). Further, in some embodiments, data from force sensors 312 and 314 is utilized in combination with data from touch sensors 332 and 334 to detect touches. Utilization of a combination of force and touch sensors allows for the detection of touch inputs while accounting for variations in temperature, bending, user conditions (e.g. the presence of a glove) and/or other factors.

In addition, touch inputs may be used to activate a device. For example, while the device is powered off, signal processor 310 may receive from one or more of sensors 312, 314, 332 and 334 a signal indicating a physical disturbance. Such a disturbance detection signal from force sensor(s) 312 and/or 314 may indicate that the device is bending (e.g. because the device is being picked up). A disturbance detection signal from touch sensor(s) 332 and/or 334 may be an acoustic signal in response to audio noise indicating that the device is being handled. In response to the disturbance detection signal, signal processor 310 enables detection of a power-on touch input. Signal processor 310 queries one or more of sensors 312, 314, 332 and 334 to determine if a power-on touch input is detected. In some embodiments, signal processor 310 and one or more of sensors 312, 314, 332 and 334 use signals that consume more power but may result in more accurate detection of a power-on touch input. If a power-on touch input is identified, then system 300 remains on and the device may be fully powered on. For example, a signal may be provided to application system 302 to energize the operating system. If a power-on touch input is not identified within a time interval, then system 300 returns to the power off mode. Stated differently, signal processor 310 returns to a low power mode and waits for a disturbance detection signal from sensor(s) 312, 314, 332 and/or 334. Consequently, system 300 allows for accurate detection of power-on touch inputs while reducing the probability that the device is turned on while in a powered off mode due to false detections of touch inputs. Thus, battery life may be better maintained, for example during shipping. Thus, detection of touch inputs using system 300 and power management for the corresponding device may be improved.

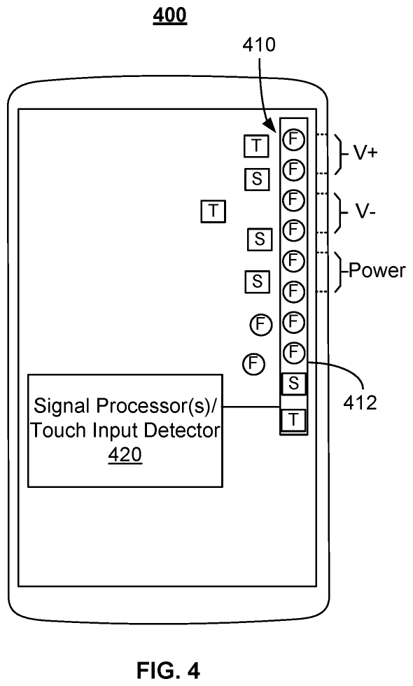

FIGS. 4-6 depict different embodiments of systems 400, 500, and 600 utilizing touch inputs for device activation. Force sensors, such as sensor(s) 100, 200, 312 and/or 314, are denoted by an “F”. Such force sensors are shown as circles and are piezoresistive (e.g. strain) sensors in some embodiments. Touch sensors such as sensor(s) 332 and/or 334 are shown by an “S”. Such touch sensors are piezoelectric sensors in some embodiments and are shown as rectangles. Transmitters, such as transmitter 330, are shown by a “T”. Such transmitters are piezoelectric sensors in some embodiments and are shown as rectangles. As indicated above, sensor component arrangements are utilized to detect a touch input along a touch surface area (e.g., to detect touch input on a touchscreen display, a portion of a mobile phone, or other region of a device desired to be sensitive to touch). The number and arrangement of force sensors, transmitters, and touch sensors shown in FIGS. 4-6 are merely examples and any number, any type and/or any arrangement of transmitters, force sensors and touch sensors may exist in various embodiments.

FIG. 4 depicts embodiments of a device 400 using sensors for power-on touch input detection. For simplicity, only portions of the device and strain sensors are shown. Device 400 includes sensor bar 410, signal processor 420, force sensors F, touch sensors S, and transmitters T. Sensor bar 410 includes force sensors F, touch sensor S, transmitter T and an underlying circuit board 412. In some embodiments, sensor bar 410 omits the touch sensors and/or transmitter. Sensor bar 410 is coupled to signal processor 420. Signal processor 420 is analogous to signal processor 310. Circuit board 412 provides mechanical stability and electrical connection for the force sensors, touch sensor and transmitter attached thereto. In some embodiments, circuit board 412 is approximately fifty millimeters long. In some embodiments, force sensors F are integrated sensors, such as integrated sensors 200. Thus, integrated sensors F may include eight strain sensors distributed in pairs at the edges, an xy sensor and an additional strain sensor in the central region, and a temperature sensor. In the embodiment shown, sensor bar 410 includes eight integrated sensors. In other embodiments, another number of integrated sensors and/or other integrated sensors may be used. In some embodiments, additional mechanisms for measuring force may be included in one or more force sensors. For example, touch sensor S (e.g. a piezoelectric sensor) may be used to detect or measure force. Sensor bar 410 may be mounted to an internal frame, such as a midframe, of device 400. In some embodiments, force sensors F, touch sensor S and transmitter T may be mounted directly on device 400 and circuit board 412 omitted. However, such mounting may present manufacturing challenges and electrical connection to force sensors would be made in another manner.

Other touch sensors, transmitters and other force sensors are located at other regions of device 400. Although not explicitly shown, the additional touch sensors, transmitters and other force sensors may be coupled with signal processor 420. In some embodiments, some or all of these transmitters, touch sensors and force sensors may be omitted; additional and/or other transmitters, touch sensors and/or force sensors may be present; and/or the locations of transmitters, touch sensors and/or force sensors may be different.

Also shown in device 400 are virtual buttons to increase volume (V+), decrease volume (V−) and turn power on/off (Power). These virtual buttons may be at the side of device 400, instead of the front face of the display. Thus, the touch surface may be at the side of device 400. In some embodiments, the touch surface may be across the front surface and/or side surface(s) of device 400. In such embodiments, virtual buttons V+, V− and/or Power may be partially or fully on the front surface of device 400. Other locations of the touch surface(s) and/or virtual buttons are possible. Dotted lines in device 400 indicate the size of virtual buttons V+, V− and Power. In some embodiments, the regions corresponding to the virtual buttons extend across multiple force sensors. In some embodiments, the regions corresponding to the virtual buttons extend across a single force sensor. The virtual buttons are regions configured to receive input forces. In some embodiments, a push of the virtual buttons applies force(s) substantially in a direction perpendicular to the long axis of sensor bar 410. A user pressing one or more of the virtual buttons (e.g. providing touch inputs to one or more of the virtual buttons) generally results in nonzero strains being measured by all of force sensors on sensor bar 410.

Force sensors corresponding to the virtual power button may be used in powering-on and powering-off device 400 using touch inputs. Thus, signal processor 420 coupled with sensor bar 410 may be used as a device activation system. Such an activation detection system may also include one or more touch sensors, force sensors and/or transmitters not on sensor bar 410.

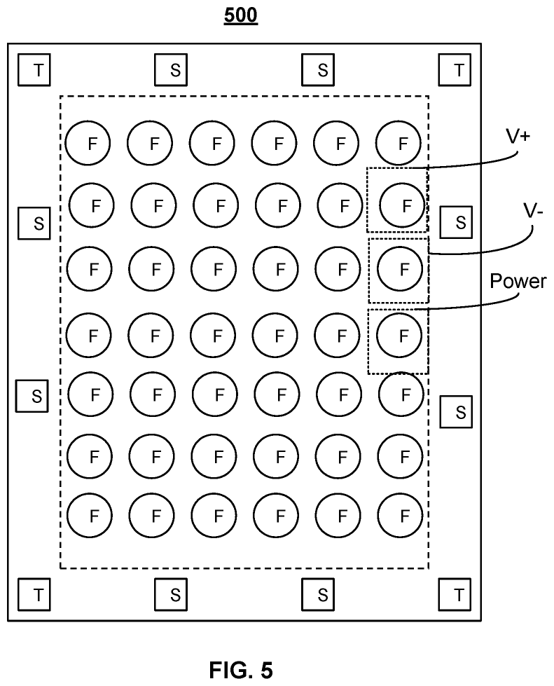

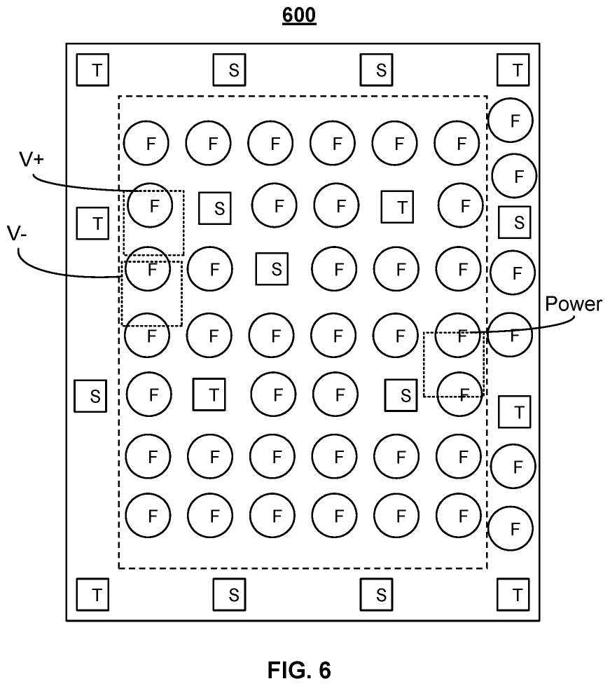

FIGS. 5 and 6 depict devices 500 and 600 that also have force sensors F, touch sensors S and transmitters T, as well as virtual buttons V+, V− and Power. Devices 500 and 600 may also include signal processor(s) that are not shown for clarity. In devices 500 and 600, the virtual buttons, sensors and transmitters are in different locations than for device 400. For example, virtual buttons are shown on the front surface of devices 500 and 600. Further, the virtual power button is separated from the virtual buttons V+ and V− in device 600. Thus, a signal processor, such as signal processor 310 or 420, coupled with virtual buttons and the corresponding force sensor(s), touch sensor(s) and/or transmitter(s) may be used as a device activation system.

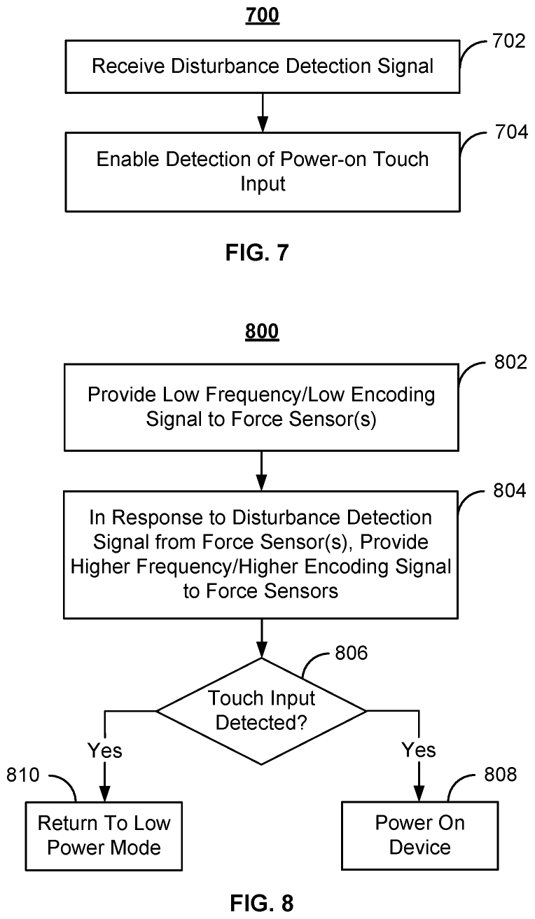

FIG. 7 is a flow chart depicting an embodiment of method 700 for utilizing touch inputs to activate a device. In some embodiments, processes of method 700 may be performed in a different order, including in parallel, may be omitted and/or may include substeps. Method 700 may be utilized when the device is powered off. For example, the device may be powered off for shipping. During shipping, the device may be subject to vibrations, jostling, contact with portions of a box or other container and/or other movement. The device is desired to be capable of undergoing shipping without remaining powered on due to false detection of touch inputs from motion such as described above. However, the device is also desired to be turned on and off using touch inputs, for example by an end user. Thus, method 700 may be used for shipping the device (e.g. as a shipping mode). In some embodiments, method 700 may also be used during normal activation of the device. In some embodiments, therefore, shipping mode and/or a low power mode are the same as the device being powered off. Thus, power consumption by the device is significantly reduced or substantially (or completely) while the device is powered off.

A disturbance detection signal is received, at 702. The disturbance detection signal indicates a physical disturbance in relation to the device, such as motion of the device or a touch of the device. For example, the disturbance detection signal may be based on strain measurement(s) indicating that the device is being bent (e.g. indicating that the device is picked up by a user, which causes the device to bend slightly). The disturbance detection signal may be based on acoustic signal(s), for example due to ambient noise as the device is removed from a box or picked up. The disturbance detection signal may be strain and/or piezoelectric signal(s) indicating that some portion of the device, such as the virtual power button, has been touched. In some embodiments, one or more of these signals may be used as a disturbance detection signal. Other disturbance detection signals due to other physical disturbances may be used in some embodiments.

In some embodiments, the disturbance detection signal is received from a single sensor. For example, a single force sensor or a single touch sensor might be utilized. In such embodiments, power may be conserved. In some embodiments, multiple sensors might be used. The disturbance detection signal is received at the signal processor in some embodiments.

Detection of a power-on touch input is enabled, at 704. A power-on touch input is a touch input that is used to turn the power to the device on if the device is powered down. In general, a power-on touch input occurs at or in proximity to a virtual power button. Thus, enabling detection of the power-on touch input includes configuring components to query and/or receive input from one or more sensors and to determine whether the power-on touch input has occurred. In some embodiments, enabling detection of the power-on touch input includes utilizing a different configuration (e.g. a larger number) of sensors. In some embodiments, enabling detection of a power-on touch input includes altering signals provided to and/or from sensors. For example, the encoding of signals may be altered (e.g. made to carry more bits per sequence), frequency of signals may be changed (e.g. increased) and/or other changes made such that detection of a power-on touch input has improved accuracy. In some embodiments, enabling detection of power-on touch inputs transitions the system from simplified use of a subset of sensors to full signal processing for a greater range of (including all) sensors. If the power-on touch input is not detected within a particular time interval, then the detection of power-on touch inputs may be deactivated. Stated differently, the enabling of the detection of power-on touch inputs at 704 may be for the particular time interval. In some embodiments, another mechanism may be used to determine under what conditions to deactivate detection of power-on touch inputs. If, however, a power-on touch input is detected, then in response the device is powered up. For example, the application system may be activated.

For example, in device 400, a disturbance detection signal is received at signal processor 420, at 702. The disturbance detection signal is received from a force sensor F, such as one of the force sensors in proximity to virtual button Power. In some embodiments, a different force sensor may be used. For example, the force sensor(s) providing the disturbance detection signal may sense a strain due to flexing of device 400 (e.g. in response to being picked up by a user), pressure due to virtual power button Power being pushed, stress due to fingers (or other items) contacting the touch surface of device 400, and/or other force(s). In some embodiments, the disturbance detection signal is received from touch sensor S on sensor bar 410. In some embodiments, another touch sensor may be used. For example, touch sensor S on sensor bar 410 may be utilized as an acoustic sensor. Acoustic vibrations, which may be due to noise made by a user opening a box containing device 400, may cause a deformation of a piezoelectric device. The deformation causes a piezoelectric device (e.g. sensor S) to emit an electrical signal. Such a signal is a disturbance detection signal and is received at signal processor 420 at 702.

Detection of power-on touch inputs by signal processor 420 and sensor bar 410 is activated, or enabled, in response to the disturbance detection signal at 704. For example, multiple force sensors F for sensor bar 410 may be utilized to determine whether virtual power button Power is pressed. This may include providing the appropriate input voltages to the inputs of all wheatstone bridges of piezoresistive sensors for force sensors F on sensor bar 410. In some embodiments, the input voltages provided at 704 are encoded with a larger bit sequence and at a higher frequency than are used for the force sensor(s) involved in disturbance detection. In some embodiments, touch sensors are also activated at 704. For example, touch sensor S on virtual power bar 410 and touch sensors S in proximity to virtual power button Power may be activated to sense a touch. In some embodiments, use of touch sensors S includes utilizing an ultrasonic signal provided from one or more transmitters T. Thus, some combination of force sensors and/or touch sensors are employed at 704 to determine whether a power-on touch input has occurred. In response to a power-on touch input being detected, device 400 is powered up. For example, an application system (not shown in FIG. 4) analogous to application system 302 is activated. If no power-on touch input is sensed in a particular interval (e.g. thirty seconds), then device 400 is put back into the power off/shipping mode. Thus, the detection of the power-on touch input may be considered to be disabled. However, physical disturbances described with respect to 702 are still detected.

Thus, using method 700, power management for a device utilizing power-on touch inputs may be improved. A single force sensor or a single touch sensor may be used in a low power mode to detect the occurrence of a disturbance, which may be related to a user preparing to turn on the device. Use of fewer sensors at 702 reduces power consumption when the device is deactivated/in shipping mode/in low power mode. Further, if less power is used per sensor, then power consumption may be further reduced. In response to a disturbance being detected, detection of power-on touch inputs is enabled. This technique for detection may use more sensors, higher frequency signals and/or more complex encoding signals. Although using more power, such a technique may more accurately detect a power-on touch input (or lack thereof). Thus, false detections of power-on touch inputs may be reduced. Further, if a power-on touch input is not detected, then the system returns to the low power/shipping mode. Consequently, power management of the device may be improved, allowing increased battery power to be available for use by the device once activated.

FIG. 8 is a flow chart depicting an embodiment of method 800 for utilizing touch inputs to activate a device. In some embodiments, processes of method 800 may be performed in a different order, including in parallel, may be omitted and/or may include substeps. Method 800 may be utilized when the device is powered off (e.g. deactivated). Thus, method 800 may be used for shipping the device (e.g. as a shipping mode) and/or may be used for normal activation of the device. The device is considered powered off at the start of method 800. In some embodiments, the device is in a shipping or low power mode/deactivated at the start of method 800. Thus, power consumption by the device is significantly reduced or substantially (or completely) while the device is powered off. Method 800 is thus analogous to method 700. Further, one or more force sensors is used in method 800.

A low frequency and/or low complexity encoded signal is provided to one or more force sensors, at 802. The force sensor(s) receiving the encoded signal at 802 are used to detect disturbances. In some embodiments, a single force sensor is used to detect disturbances. Thus, the low frequency/low complexity encoded signal may be provided to a single force sensor at 802. The force sensor(s) used may be integrated force sensor(s) or single strain gauge(s). The encoded signal provided may be the input voltage signal to the inputs of the strain sensors, such as strain sensor 100 in sensor 100, 200, 312 or 314. In some embodiments, the encoded signal is low frequency in comparison to signals used with the force sensors after the device is powered on. Similarly, a low complexity encoded signal utilizes less complex encoding in comparison to signals used with force sensors after the device is powered on. In some environments, the signals provided in 802 may be PRBS signals with fewer bits per sequence than PRBS signals utilized when the device in 804. For example, a PRBS6 (a sixty four bit sequence) signal at a frequency of 0.5 Hz, 1 Hz or 5 Hz may be used in 802. In response to detecting a disturbance, the force sensor(s) receiving the encoded signal at 802 provide a disturbance detection signal. In some embodiments, the disturbance detection signal is also a PRBS6 sequence signal at or near the frequency of the input signal. Use of a coded waveform in order to detect disturbances may reduce the occurrence of false disturbance detections, for example due to changes in temperature.

In response to a disturbance detection signal from the force sensor(s), a higher frequency and/or higher encoded signal is provided to force sensor(s), at 804. Thus, a higher SNR signal may be used to query force sensor(s) at 804. In other embodiments, a signal that is the same SNR (e.g. same frequency and/or same encoding) is provided at 804. Using 804, therefore, a power-on touch input may be identified. Stated differently, detection of a power-on touch input is enabled. In some embodiments, the number of force sensors to which the signal is provided at 804 increases. For example, while the low frequency/low complexity encoded signal of 802 may be provided to a single force sensor, the high frequency/higher complexity encoded signal of 804 may be provided to multiple sensors in proximity to a virtual power button or to all force sensors for a device. In some embodiments, the force sensor(s) receiving signals at 804 include the force sensors that receive signals at 802. In some embodiments, however, different force sensors are used in 802 and 804. The encoded signal provided may be the input voltage signal to the inputs of the strain sensors, such as strain sensor 100 in sensor 100, 200, 312 or 314.

In some embodiments, the encoded signal of 804 is high frequency in comparison to signals used with the force sensors in 802. Similarly, the encoded signal of 804 utilizes more complex encoding in comparison to signals used with force sensors for 802. In some embodiments, the signals provided in 804 may be PRBS signals with more bits per sequence than PRBS signals utilized for detecting a disturbance in 802. For example, a PRBS9 (a five hundred and twelve bit) sequence may be utilized in 804, while a PRBS6 (a sixty four bit) sequence may be used at 802. Similarly, a frequency of 10 Hz or higher may be utilized at 804, while a frequency of 0.5, 1 Hz or 5 Hz may be used in 802. Thus, a higher complexity encoding and/or higher frequency signal may be used to query force sensors at 804. In some embodiments, an encoding signal of the same complexity and frequency is used to query force sensors at 804. Also at 804, responses to any touches may be received from force sensors.

In addition, 804 may include receiving data from touch sensors. In some embodiments, 804 includes providing an ultrasonic signal to touch sensors. This ultrasonic signal may also be encoded. The data received at 804 from the touch sensors indicates a touch. Thus, in some embodiments, force sensors and touch sensors are utilized at 804 to determine whether a power-on touch input is received.

Based on the signals provided to sensors and received from sensors at 804, it is determined whether a power-on touch input is detected, at 806. Thus, the responses to the encoded signals provided to force sensors at 804, as well as any signals from touch sensors, may be analyzed. For example, for signals received from force sensors, the temperature change(s) to force sensors and baseline for the force sensors may be accounted for. Short and long time scale changes in temperature may greatly affect the force measured by force sensors. The changes in the baseline output signal from force sensors may be due to temperature as well as other effects. Thus, the signals from the force sensors are processed to account for (e.g. remove or mitigate) the effects of temperature and/or baseline drift. In some embodiments, this is distinct from the disturbance detection signals provided at 802, which may not account for baseline and/or temperature changes.

For example, effects of changes in temperature and mismatches between the coefficient of thermal expansion (CTE) of the force sensor/strain gauge (e.g. silicon) and the CTE of the surface to which the force sensor is mounted (e.g. metal) on strain measurements are modeled. The CTE for the force sensor may be on the order of 4 parts per million (PPM) per degree Celsius. The CTE for the portion of the device to which the force sensor is mounted may be 25-30 PPM/degree Celsius. Differences in the expansion of the force sensor and the device may result in a strain that is significantly larger than the strain induced by a touch input. To address this issue the strains due to temperature changes may be modeled and subtracted from the measured strain. For example, the temperature induced strain, STR, may be given by STR=α₀+α₁T+α₂T², where T is the temperature and αᵢ, where i=1, 2, 3 . . . are coefficients that are a function of temperature and material. The coefficient α₀ may be based on the static inherent stress in the system and, in theory, may be zero. The coefficient α₁ is the linear component of the thermal expansion and is what is generally thought of as the coefficient of thermal expansion. The coefficient α₂ is the second order component of the CTE and may account for effects such as the adhesive used to bond the force sensor to the device. In some embodiments, higher order terms may also be employed. These coefficients may be dynamically adapted over time to provide the temperature induced strain. In some embodiments, the baseline strains when the device is not being touched and the temperature may be used to update these coefficients. As discussed above, the temperature may be provided from a temperature sensor on an integrated force sensor. For example, temperature sensor 250 on force sensor 200 may provide the temperature. In some embodiments, the temperature may be provided for the model by providing a signal back to the signal processor, such as signal processor 420. The signal may be an oscillating signal that has a frequency that is directly proportional to the temperature. A frequency counter in the signal processor may then be used to readily determine the temperature. The modeled temperature induced strain may be removed from the measured strain from the force sensors when detecting touch inputs.

In some embodiments, measurements from both touch and force sensors are sufficiently correlated for a touch input to be detected. Thus, the touch input detection may be based on both force and touch sensors. In some embodiments, only force sensors are used. In other embodiments, only touch sensors are used. Also in some embodiments, there is a time interval for detecting a touch input. For example, not more than thirty second may elapse between the time the high frequency/higher complexity encoded signal is provided at 804 and the power-on touch input is identified for it to be determined in 806 that a power-on touch input is detected. In some embodiments, another time interval or other criteria for determining when a touch input is likely to occur, may be used.

If a power-on touch input is not detected within the time interval, then the device is returned to a low power (e.g. off or shipping) mode, at 810. If, however, the power-on touch input is detected at 806, then the device is powered up at 808.

For example, in device 400, low frequency, low complexity encoded signals are provided by signal processor 420, at 802. For example, a PRBS6 sequence signal at 1 Hz may be provided to a force sensor in proximity to virtual power button Power. Thus, a force sensor is periodically queried in a low power manner. If a disturbance (e.g. a strain) is detected by the force sensor, then the force sensor provides a signal back to signal processor 420. Thus, the disturbance detection signal is received from a force sensor F.

In response to the disturbance detection signal received at 802, a higher complexity encoding/higher frequency signal is provided at 804. For example, signal processor 420 may provide a PRBS9 sequence signal at 10 Hz or more to the voltage inputs of each strain sensor for each of the multiple force sensors F for sensor bar 410. In some embodiments, touch sensor S on virtual power bar 410 and touch sensors S in proximity to virtual power button Power may be activated to sense a touch. In some embodiments, this includes utilizing an ultrasonic signal provided from one or more transmitters T. Also at 804 corresponding signals may be received at signal processor 420 from force and/or touch sensors. Thus, some combination of force sensors and/or touch sensors are utilized at 804 to determine whether a power-on touch input is provided.

Signal processor 420 determines whether a touch input is detected, at 806. As discussed above, this may include tracking the baseline measurements for force sensors, accounting for temperature and baseline changes of force sensors, and processing the signals received as part of 804. In some embodiments, 806 includes correlating the forces detected by the force sensors and correlating measurements of force by force sensors and touch sensors.

In response to a power-on touch input being detected, device 400 is powered up at 808. For example, an application system (not shown in FIG. 4) analogous to application system 302 is activated. If no power-on touch input is sensed in a particular interval (e.g. thirty seconds), then device 400 is put back into the power off/shipping mode at 810. Thus, the detection of power-on touch input is deactivated.

Thus, using method 800, power management for a device utilizing power-on touch inputs may be improved. A single force sensor may be used in a low power mode (e.g. low frequency/low complexity encoding signal) to detect the occurrence of a disturbance, which may be related to a user preparing to turn on the device. Thus, power may be conserved when the device is not operating because fewer sensor(s) are utilized and because less power is used per sensor. Use of a coded waveform may also reduce the occurrence of false disturbance detections, for example due to changes in temperature or bending. In response to such a disturbance being detected, the power-on touch input detection is enabled. For example, higher frequency/higher complexity encoding signals may be used. Although using more power, such detection may more accurately detect a power-on touch input (or lack thereof). Thus, false detections of power-on touch inputs may be reduced. Consequently, power management of the device may be improved, allowing increased battery power to be available for use by the device once activated.

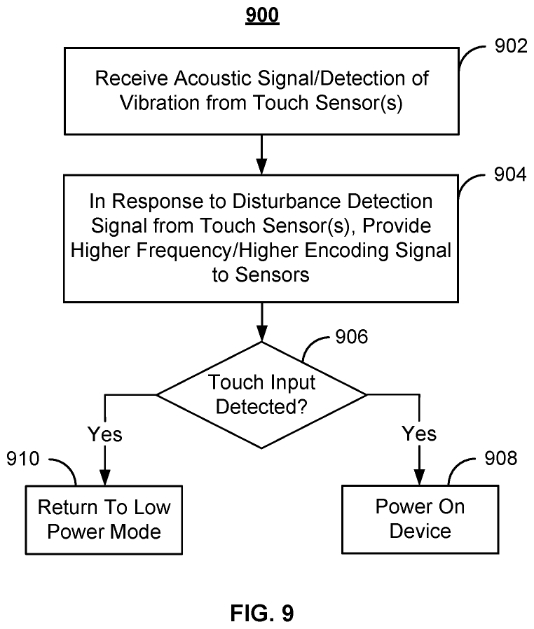

FIG. 9 is a flow chart depicting an embodiment of method 900 for utilizing touch inputs to activate a device. In some embodiments, processes of method 900 may be performed in a different order, including in parallel, may be omitted and/or may include substeps. Method 900 may be utilized when the device is powered off (e.g. deactivated). Thus, method 900 may be used for shipping the device (e.g. as a shipping mode) and/or may be used for normal activation of the device. The device is considered powered off at the start of method 900. In some embodiments, the device is in a shipping mode/deactivated at the start of method 900. Thus, power consumption by the device is significantly reduced or substantially (or completely) while the device is powered off. Method 900 is thus analogous to method 700. Further, one or more touch sensors is used in method 900.

A disturbance detection signal based on acoustic detection is received, at 902. In some embodiments, the disturbance detection signal is received from piezoelectric device(s) configured to function as microphone(s). In some such embodiments, the piezoelectric device(s) are touch sensor(s). In some embodiments, a single touch sensor is used to detect disturbances. Although described in the context of touch sensors that may already exist in a device, in some embodiments, piezoelectric or other device(s) configured only to be used as microphone(s) provide the signal at 902. In some embodiments, the touch sensors provide the disturbance detection signal in response to sounds in the range of 5-500 Hz. For example, a touch sensor may be configured to scan at a frequency of 3-10 Hz for acoustic vibrations in the range of 5-500 Hz. If such vibrations exceeding a threshold are detected by a touch sensor, a corresponding disturbance detection signal is provided by the touch sensor. In some embodiments, the disturbance detection signal provided by the touch sensor.

In response to receiving the disturbance detection signal from the touch sensor(s), a high frequency and/or higher complexity encoded signal is provided to force sensor(s), at 904. Stated differently, power-on touch input detection is enabled. Using 904, therefore, a power-on touch input may be identified. In some embodiments, the encoded signal of 904 is a PRBS9 sequence. In some embodiments, the PRBS9 sequence is provided at a frequency at 10 Hz or higher. Thus, a higher encoding and/or higher frequency signal may be used to query force sensors at 904. Also at 904, responses to any touches may be received from force sensors. In some embodiments, the full complement of force and touch sensors are activated at 904. Thus, in addition to providing the encoded signal to force sensors, ultrasonic signals are provided to touch sensors. This ultrasonic signal may also be encoded. The data received at 904 from the touch sensors indicates a touch. Thus, in some embodiments, force sensors and touch sensors are utilized at 904 to determine whether a power-on touch input is received.

Based on the signals provided at 904, it is determined whether a power-on touch input is detected, at 906. In some embodiments 906 is analogous to 806 of method 800. For example, for signals received from force sensors, the temperature change and baseline may be accounted for. Thus, the signals from the force sensors are processed to account for (e.g. remove or mitigate) the effects of temperature and/or baseline changes. In some embodiments, measurements from both touch and force sensors are sufficiently correlated for a touch input to be detected. Thus, the touch input detection may be based on both force and touch sensors. In some embodiments, only force sensors are used. In other embodiments, only touch sensors are used. Also in some embodiments, there is a time interval for detecting a touch input. For example, not more than thirty second may elapse between the time the high frequency/higher complexity encoded signal is provided at 904 and the power-on touch input is identified for it to be determined in 906 that a power-on touch input is detected. In some embodiments, another time interval or other criteria for determining when a touch input is likely to occur, may be used.

If a power-on touch input is not detected within the time interval, then the device is returned to a low power (e.g. off or shipping) mode, at 910. If, however, the power-on touch input is detected at 906, then the device is powered up at 908.

For example, in device 400, a touch sensor such as touch sensor S that is part of sensor bar 410 provides a disturbance detection signal in response to sounds in the range of 5-500 Hz. The touch sensor provides the disturbance detection signal to signal processor 420, at 902.

In response to the disturbance detection signal received at 902, power-on touch input is enabled at 904. For example, signal processor provides a high encoding/high frequency signal to force sensors at 904. For example, signal processor 420 may provide a PRBS9 sequence signal to the voltage inputs of each strain sensor for each of the multiple force sensors F for sensor bar 410. In some embodiments, touch sensor S on virtual power bar 410 and touch sensors S in proximity to virtual power button Power may be activated to sense a touch. In some embodiments, this includes utilizing an ultrasonic signal provided from one or more transmitters T. Also at 904 corresponding signals may be received at signal processor 420 from force and/or touch sensors. Thus, some combination of force sensors and/or touch sensors are utilized at 904 to determine whether a power-on touch input is provided.

Signal processor 420 determines whether a touch input is detected, at 906. As discussed above, this may include tracking the baseline measurements for force sensors, accounting for temperature and baseline changes of force sensors, and processing the signals received as part of 904. In some embodiments, 906 includes correlating the forces detected by the force sensors and correlating measurements of force by force sensors and touch sensors.

In response to a power-on touch input being detected, device 400 is powered up at 908. For example, an application system (not shown in FIG. 4) analogous to application system 302 is activated. If no power-on touch input is sensed in a particular interval (e.g. thirty seconds), then device 400 is put back into the power off/shipping mode at 910. Thus, detection of power-on touch inputs is disabled.

Thus, using method 900, power management for a device utilizing power-on touch inputs may be improved. A single acoustic sensor may be used in a very low power mode to detect the occurrence of a disturbance, which may be related to a user preparing to turn on the device. Thus, power may be conserved when the device is not operating because fewer sensors are utilized and because significantly less power is used per sensor. In response to such a disturbance being detected, detection of power-on touch inputs is enabled. Techniques for detection of power-on touch inputs may use more sensors, higher frequency signals and/or more complex encoded signals. Although using more power, such techniques may more accurately detect a power-on touch input (or lack thereof). Thus, false detections of power-on touch inputs may be reduced. Consequently, power management of the device may be improved, allowing increased battery power to be available for use by the device once activated.

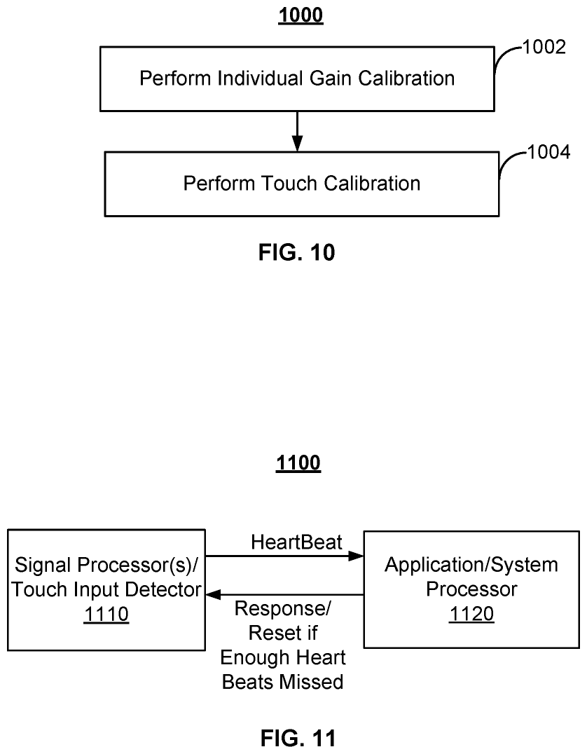

FIG. 10 is a flow chart depicting an embodiment of method 1000 for calibrating force sensors for use in detecting touch inputs for device activation and/or other uses. In some embodiments, processes of method 1000 may be performed in a different order, including in parallel, may be omitted and/or may include substeps. In some embodiments, method 1000 is performed for force sensors, such as force sensors 100, 200, 312, 314 and F. For example, in some embodiments, sensors F are calibrated using method 1000.

A gain calibration for the sensor is performed for each device, at 1002. In some embodiments, a known point load to a known point on top of each sensor after the sensor is mounted on the device. As a result, the variations attachment(s) of the sensor can be accounted for. For example, for each sensor F of sensor bar 410, the force sensor F is attached to printed circuit board 412 and printed circuit board 412 is attached to the device. Calibration of gain after mounting allows for variations in gain due to mounting to be accounted for. For example, a five hundred gram load may be applied to each sensor. The corresponding signals output for each load and each sensor are also determined at 1002. In some embodiments, the gain for each sensor is also normalized at 1002. Thus, variations in the magnitude of the input force a user applies when providing a touch input to the device may be accounted for. Thus, 1002 allows for variations between units (e.g. devices of the same type) to be accounted for.

A calibration of touch inputs is performed, at 1004. The calibration for touch inputs performed at 1004 may be performed once per model, instead of per unit. Thus, the strains associated with a finger press on power key are determined. In some embodiments, 1004 is performed by having a cohort including a variety of users (e.g. old and young, large and small, male and female, etc.) carrying out virtual button presses. In some embodiments, a precalibrated vector of strains for the force sensors corresponds to the virtual button press. Thus, in order to determine whether a virtual button, such as the virtual power button is pressed, it may be determined whether the corresponding strains from the force sensors F are sufficiently close to (e.g. within a particular distance from) the precalibrated vector. Thus, using method 1000 the force sensors may be calibrated for use in the detecting power-on touch inputs. Consequently, force sensors may be better able to detect physical disturbances as well as identify touch inputs.

FIG. 11 is a diagram depicting an embodiment of system 1100 for maintaining a signal processor. System 1100 may be part of devices, such as one containing system 100, 200, 300, 400, 500 and/or 600.

Signal processor 1110 is analogous to signal processors 320 and 420, respectively. Application system 1120 is analogous to application system 302. For clarity, other portions of system 1100 are not shown. System 1100 is utilized to ensure that signal processor 1110 remains operational.

In addition to its other activities, signal processor 1110 provides a heartbeat signal to application processor 1120. The heartbeat signal is periodic, for example occurring once every ten seconds. In response, application system 1120 provides a response signal. However, if signal processor 1110 crashes, then no heartbeat signal is provided. Consequently, signal processor 1110 is desired to be reset. Consequently, in response to a particular number of missed signals, for example three missed heartbeats, application system 1120 sends a reset signal to signal processor 1110. In response, signal processor 1110 is rebooted. Thus, system 1100 ensures that the touch input detection system, for example systems 300, 400, 500 and/or 600, remain capable of detecting touch inputs. Reliability of system 1100 is thus improved. That improvement in reliability is desirable because we are in the power on key—that is also why double encoding—to not have a false power event.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A device activation system, comprising:
a sensor; and
a signal processor configured to:
receive a disturbance detection signal from the sensor; and
in response to receiving the disturbance detection signal, enable detection of a power-on touch input.

2. The system of claim 1, wherein to enable detection of the power-on touch input, the signal processor is further configured to:
utilize a first encoded signal at a first frequency to query at least a portion of a plurality of sensors to detect the power-on touch input.

3. The system of claim 2, wherein the sensor is a force sensor and wherein the signal processor is further configured to provide a second encoded signal to the sensor in a low power mode, the disturbance detection signal received from the force sensor corresponding to the second encoded signal.

4. The system of claim 3, wherein the plurality of sensors include a plurality of force sensors and wherein the signal processor is further configured to return to the low power mode if the power-on touch input is not identified within a time interval.

5. The system of claim 2 wherein the first encoded signal has a first signal-to-noise ratio and the second encoded signal has a second signal-to-noise ratio not less than the first signal-to-noise ratio.

6. The system of claim 1, wherein to receive the disturbance detection signal from the sensor, the signal processor is further configured to:
receive the disturbance detection signal only from the sensor.

7. The system of claim 1, wherein the sensor is a touch sensor and the disturbance detection signal includes an acoustic-based signal from the touch sensor.

8. A method, comprising:
receiving a disturbance detection signal from a sensor; and
enabling detection of a power-on touch input in response to the disturbance detection signal.

9. The method of claim 8, further comprising:
utilizing a first encoded signal at a first frequency to query at least a portion of a plurality of sensors to detect the power-on touch input.

10. The method of claim 9, further comprising:
providing a second encoded signal to the sensor, the disturbance detection signal corresponding to the second encoded signal and being received from the sensor.

11. The method of claim 10, wherein the first encoded signal has a first signal-to-noise ratio and the second encoded signal has a second signal-to-noise ratio not less than the first signal-to-noise ratio.

12. The method of claim 8, wherein the receiving the disturbance detection signal includes:
receiving the disturbance detection signal only from the sensor.

13. A computer program product, the computer program product being embodied in a tangible computer readable storage medium and comprising computer instructions for:
receiving a disturbance detection signal from a sensor; and
enabling detection of a power-on touch input in response to the disturbance detection signal.

14. The computer program product of claim 13, wherein the computer instructions further include computer instructions for:
utilizing a first encoded signal at a first frequency to query at least a portion of a plurality of sensors to detect the power-on touch input.

15. The computer program product of claim 14, wherein the computer instructions further include computer instructions for:
providing a second encoded signal to the sensor, the disturbance detection signal corresponding to the second encoded signal and being received from the sensor.

16. The computer program product of claim 15, wherein the first encoded signal has a first signal-to-noise ratio and the second encoded signal has a second signal-to-noise ratio not less than the first signal-to-noise ratio.

17. The computer program product of claim 13, wherein the receiving disturbance detection signal further includes:
receiving the disturbance detection signal only from the sensor.
